(19) United States
(12) Patent Application Publication
(10) Pub. No.: US 2019/0305812 A1
(43) Pub. Date: Oct. 3, 2019

(54) Headset Wire Selection for Device Antenna

(71) Applicant: Qualcomm Incorporated, San Diego, CA (US)

(72) Inventors: Arild Kolsrud, El Cajon, CA (US); Pranav Iyengar, San Diego, CA (US)

(21) Appl. No.: 16/181,067

(22) Filed: Nov. 5, 2018

Related U.S. Application Data
(60) Provisional application No. 62/660,793, filed on Apr. 20, 2018.

(30) Foreign Application Priority Data
Mar. 29, 2018 (IN) 201841011901

(51) Int. Cl. H04B 1/18; H04B 1/3805; H04B 17/318

(52) U.S. Cl. CPC H04B 1/18; H04R 1/1033; H04B 17/318; H04B 1/3805

(57) ABSTRACT

An apparatus is disclosed for headset wire selection for a device antenna. In example aspects, an apparatus includes multiple audio lines, a radio receiver, and a switch. The multiple audio lines are configured to be coupled to an audio socket, and the radio receiver is configured to demodulate a radio signal. The switch is coupled between the multiple audio lines and the radio receiver, and the switch is configured to selectively connect an audio line of the multiple audio lines to the radio receiver.

### RELATED APPLICATION(S) AND PRIORITY INFORMATION

This application claims the benefit of U.S. Provisional Patent Application No. 62/660,793 filed 20 Apr. 2018, which, in turn, claims priority to Indian Provisional Patent Application No. 201841011901 filed 29 Mar. 2018, of which the entire contents of both disclosures are hereby incorporated by reference herein. Thus, this application also claims priority to Indian Provisional Patent Application No. 201841011901 filed 29 Mar. 2018.

### TECHNICAL FIELD

This disclosure relates generally to radio frequency (RF) wireless signal reception and, more specifically, to selection of an audio line, which can be coupled to a wire of a headset to serve as an antenna for an electronic device to receive radio signals.

### BACKGROUND

Examples of electronic devices include desktop computers, notebook computers, tablet computers, smartphones, and wearable devices such as a smartwatch, a fitness tracker, or intelligent glasses. People use electronic devices for productivity, communication, and entertainment purposes. For example, people play media, such as audio or video, using electronic devices. The media may be stored locally at an electronic device or transmitted to the electronic device. With the advent of high-bandwidth streaming capabilities, many people stream music, live radio, and podcasts to their electronic devices using Wi-Fi or cellular networks.

However, Wi-Fi hotspots are typically limited to areas in or near buildings. Further, Wi-Fi hotspots sometimes require a fee or specialized login access. Cellular networks tend to offer a greater coverage area than Wi-Fi hotspots and are adept at servicing electronic devices that are in motion, such as from traveling or exercising. Unfortunately, cellular networks are bandwidth limited in the sense that additional streamed bytes cost additional funds, either on a per-byte basis or by pre-purchasing a larger bucket of bytes. In view of these issues, there is another option, which does not require streaming from Wi-Fi or cellular networks, for transmission of signals to electronic devices: terrestrial radio.

Terrestrial radio is an attractive option to many users of electronic devices. It is an especially attractive option for broadcast radio because terrestrial radio is typically free. Additionally, radio signals can be received while an electronic device is in motion or is located in a remote area far from Wi-Fi hotspots or cellular coverage. Further, listening to terrestrial radio can save battery power or enable cellular bandwidth usage to be conserved. However, enabling an electronic device to receive radio signals can be problematic.

### SUMMARY

Performing or enabling headset wire selection for an antenna of an electronic device is disclosed herein. In many areas of the world, it is desirable to receive radio signals, such as commercial frequency-modulated (FM) radio signals, using an electronic device, such as a smartphone or a smart watch. Generally, an electronic device, especially a portable one, has an audio socket for receiving an audio plug that is part of an audio headset. The headset includes a cable that extends between the audio plug and an audio endpoint of the headset. The cable includes multiple wires that may be usable as an antenna for radio signal reception. However, one wire may be more suitable for use as an antenna than another wire because the other wire is, for example, shielded or noisy compared to the one wire.

In example implementations, an electronic device, or a portion thereof, includes multiple audio lines coupled between an audio socket and audio circuitry. The multiple audio lines can be coupled to the wires of the cable of the headset via multiple contacts of the audio plug. To enable different audio lines of the electronic device—and thus different wires of a headset that is coupled to the electronic device—to be selectively coupled to a radio receiver, a switch of the electronic device is coupled between the multiple audio lines and the radio receiver. A particular audio line can be selected for connecting to the radio receiver by cycling through different positions of the switch and comparing respective resulting signal strengths of a received radio signal. To reduce the switch cycling and save time on the signal strength measurement process, some described implementations enable a position of a microphone contact to be inferred relative to one of a ground contact using a location (e.g., a geographic region) of the electronic device. Other example implementations for headset wire selection for an antenna of an electronic device are described with respect to apparatuses, systems, electronic devices, arrangements, methods, and so forth.

In an example aspect, an apparatus is disclosed. The apparatus includes multiple audio lines configured to be coupled to an audio socket. The apparatus also includes a radio receiver configured to demodulate a radio signal. The apparatus further includes a switch coupled between the multiple audio lines and the radio receiver. The switch is configured to selectively connect an audio line of the multiple audio lines to the radio receiver.

In an example aspect, an apparatus is disclosed. The apparatus includes multiple audio lines configured to be coupled to an audio socket. The audio socket is configured to accept an audio plug of a headset having a cable that includes multiple wires. The apparatus also includes a radio receiver. The apparatus further includes switch means for selectively connecting an audio line of the multiple audio lines to the radio receiver to enable different antennas to be established for the radio receiver using respective ones of the multiple wires.

In an example aspect, a method for headset wire selection for antenna usage by an electronic device is disclosed. The method includes receiving a first signal via a first audio line of multiple audio lines and measuring a first signal strength of the first signal. The method also includes adjusting a switch from a first position to a second position. Responsive to the adjusting, the method additionally includes receiving a second signal via a second audio line of the multiple audio lines and measuring a second signal strength of the second signal. The method further includes establishing a position of the switch based on the first signal strength and the second signal strength.

In an example aspect, an electronic device is disclosed. The electronic device includes an audio socket and multiple audio lines coupled to the audio socket. The electronic device also includes audio circuitry coupled to the multiple audio lines and a radio receiver configured to demodulate a radio signal. The electronic device further includes a switch coupled between the multiple audio lines and the radio receiver, with the switch configured to selectively connect an audio line of the multiple audio lines to the radio receiver.

### BRIEF DESCRIPTION OF DRAWINGS

FIG. 1 illustrates an example environment that includes an electronic device in which headset wire selection for device antenna can be implemented.

FIG. 2 is a schematic diagram illustrating an example portion of an electronic device including a switch that is coupled between multiple audio lines and a radio receiver and that is controlled by audio line selection circuitry.

FIG. 3 is a flow chart illustrating an example scheme for switch control circuitry that is configured to operate the switch based on signal strength.

FIG. 4-1 is a schematic diagram depicting an example support structure of an electronic device with the switch in a first position to obtain a first signal strength.

FIG. 4-2 is a schematic diagram depicting an example support structure with the switch in a second position to obtain a second signal strength.

FIG. 4-3 is a schematic diagram depicting an example support structure with the switch in a third position to obtain a third signal strength.

FIG. 5 is a schematic diagram illustrating another example support structure of an electronic device including a switch that is coupled between multiple audio lines and a radio receiver and that is controlled by audio line selection circuitry to identify an audio plug configuration based on a location.

FIG. 6 is a flow chart illustrating an example scheme for wire identification circuitry that is configured to identify an audio plug configuration based on a location.

FIG. 7 is a flow diagram illustrating an example process for headset wire selection for a device antenna.

FIG. 8 illustrates an example electronic device, which includes an audio line selection switch, that can implement headset wire selection for a device antenna.

### DETAILED DESCRIPTION

Although many users of electronic devices choose to stream digital audio using Wi-Fi or cellular technology, receiving audio via radio signals (e.g., terrestrial radio) is also attractive to many users. This is especially true for receiving live or local broadcast radio and for obtaining audio in “remote” areas that do not offer Wi-Fi or cellular coverage. Additionally, obtaining audio via radio signals can reduce bandwidth usage on metered cellular plans to thereby save a user money. Further, battery power can be conserved because radio signal reception typically uses less power than receiving and decoding audio that is streamed via Wi-Fi or cellular networks. However, receiving radio signals with a portable or similarly-small electronic device is problematic.

Typically, commercial frequency-modulated (FM) radio signals are propagated in a radio-frequency band spanning approximately 76 megahertz (MHz) to approximately 108 MHz. For example, much of the world devotes 87.5 to 108 MHz to commercial FM radio signals, and Japan assigns 76 to 95 MHz to commercial FM radio signals. An effective antenna for this frequency band includes, for instance, a monopole having a length of approximately one quarter of a wavelength of the signal (e.g., about 76 cm or 2.5 feet). Thus, incorporating an FM radio antenna directly into a small portable device, such as a smartphone or smart watch, is prohibitively difficult due to the size difference between the small portable device and an antenna that is over two feet long. Consequently, most portable electronic devices cannot easily contain an effective antenna for commercial FM radio signals.

However, because many electronic devices include a receptacle for connecting an auditory headset via a cable, a wire that is contained in the cable of the headset and that extends from the audio plug to or toward the headset speakers is an acceptable option as an FM antenna for an electronic device. For instance, one of the audio wires in a headset cable can be used, or shared, as the FM radio antenna. Many headsets have a non-shielded cable. This is particularly true for lower-cost and earbud-style headsets. With unshielded cables, any audio wire of the cable can theoretically be employed as an FM antenna, but right and ground audio wires are commonly used. The right audio wire of the headset typically provides superior performance because the ground wire is connected to the ground plane of the electronic device. Thus, the ground wire usually introduces noise into a received FM radio signal.

For higher quality headsets, shielded cables are often used. The shielding can be implemented as, for instance, a sheath that wraps around or otherwise substantially surrounds a wire of the cable and prevents—or significantly attenuates—FM radio signals from reaching the shielded wire. With such higher quality headsets, the right audio wire is inside the shielded portion of the cable and cannot be effectively used as an FM radio antenna due to the shielding. Consequently, manufacturers of electronic devices cannot produce a design that always uses a same, single wire of a headset cable while simultaneously ensuring than the optimum wire of the cable is employed as an antenna for an electronic device.

Unfortunately, employing a headset wire as an antenna of an electronic device is actually more complicated. This complication arises because there are different standards around the world for designing or producing an audio plug of a headset. The audio plug or audio connector has multiple contacts or pins for electrically interfacing with an audio socket of an electronic device. Typically, each of these contacts is coupled to a wire included in a cable of the corresponding headset. These respective contacts and respective wires can include: a right audio part, a left audio part, a microphone audio part, and a ground part. In the European and North American standard configurations, the physical location of the microphone and the ground contacts on a 3.5 millimeter (mm) audio plug are swapped with respect to each other. With the European standard, the contact that is farthest from the tip is used for ground. With the North American standard, on the other hand, the contact that is farthest from the tip is used for the microphone. Different countries around the world have adopted one standard or the other. Thus, these configurations vary by country with some adhering to the North American configuration and some adhering to the European configuration.

As described above, because the shielding properties of individual wires of a headset cable are unknown, an electronic device is unaware of which wire (e.g., a signal-carrying wire or a ground wire) should be employed as an antenna for the electronic device. Further, because of the competing audio plug configuration standards, the electronic device is also unaware of which contact in the audio socket thereof is coupled to which wire of the headset cable. These issues individually and jointly make it difficult for an electronic device to use a best available wire, or even a better available wire, of a headset cable as an antenna for receiving radio signals, such as commercial FM radio signals.

In contrast, example approaches as described herein employ a switch that can selectively couple a particular wire of the headset cable to a radio receiver of an electronic device for use as an antenna using a described audio line selection technique. The switch is coupled between the radio receiver and multiple audio lines disposed within the electronic device (e.g., disposed on a support structure such as a frame or printed circuit board (PCB)). The multiple audio lines are coupled to an audio socket of the electronic device. In operation, an audio line selection scheme cycles through different switch positions, and thus different wires of the headset cable, and selects one wire for use as an antenna based on received signal strength. Thus, a wire with at least a better signal strength can be employed as the antenna for the radio receiver. In other example approaches, an electronic device implements a wire identification technique. The electronic device ascertains a location, such as a geographic region (e.g., a continent or country), in which the device is currently located. Using a look-up table that maps locations to an audio plug configuration standard, the device infers a likely audio plug configuration responsive to the ascertained location. Based on the inferred audio plug configuration, the electronic device can identify which wire of the headset cable is coupled to which contact of the audio plug of the headset, and thus to which audio line of the audio socket of the electronic device.

In an example implementation for headset wire selection for device antenna, an electronic device includes an audio socket and multiple audio lines coupled to the audio socket. The electronic device further includes a radio receiver, a switch coupled between the multiple audio lines and the radio receiver, and audio line selection circuitry. The multiple audio lines, the switch, the radio receiver, and the audio line selection circuitry can be disposed on a support structure of the electronic device. The audio line selection circuitry can include wire identification circuitry and switch control circuitry. The audio line selection circuitry detects that an audio plug of a headset has been received in the audio socket. In response, the wire identification circuitry uses a look-up table to infer an audio plug configuration based on an ascertained location of the electronic device. The wire identification circuitry can identify which audio line comprises a, e.g., ground line based on the inferred audio plug configuration.

The switch control circuitry places the switch in a position to connect the identified ground line to the radio receiver. The radio receiver tunes to a radio station, such as an FM radio station, and determines a received signal strength (RSS) while using the ground line as an antenna. The switch control circuitry stores the RSS for the ground line in association with the switch position. The switch control circuitry further places the switch in another position to connect another audio line, such as the right audio line, to the radio receiver. The radio receiver determines another RSS while using the right audio line as an antenna and stores the other RSS in association with the other switch position. The switch control circuitry can cycle through any remaining switch positions and determine a corresponding RSS value and store the corresponding RSS value in association with the respective switch position. The switch control circuitry compares the determined RSS values and places the switch into a position to use the audio line having at least a higher RSS value (e.g., a value above a lowest RSS value) as the antenna for the radio receiver. If, for example, the RSS value for the ground line is more than 30 decibels (dB) above that of the right audio line, then the right audio line is likely shielded.

In some alternative implementations, the switch control circuitry can leave the switch in the position identified by the wire identification circuitry without testing other switch positions and/or without determining any RSS value to save time or to reduce circuitry complexity (e.g., by omitting circuitry directed to comparative antenna signal strength analysis). In other alternative implementations, the wire identification circuitry can be omitted. Instead, the switch control circuitry can cycle through each of the available switch positions, which can number as high as the number of audio lines coupled to the audio socket, without starting at any particular switch position to reduce circuitry complexity (e.g., by omitting circuitry directed to identifying an initial switch position via location-based inference, such as the wire identification circuitry). For each switch position, the radio receiver determines an RSS value. The switch control circuitry can select a switch position, and thus an audio line that is coupled to a headset wire for use as an antenna for the radio receiver, based on the RSS values.

In these manners, an electronic device can provide an antenna for a radio receiver using a wire of a cable of a headset in different scenarios. For example, the cable can have one or more wires that are shielded. Furthermore, the audio plug can have any of multiple different configurations, such as one comporting with a North American standard or with a European standard. Consequently, an electronic device can reliably provide FM radio reception without requiring a particular type of handset, which increases the flexibility, versatility, reliability, and trustworthiness of the device.

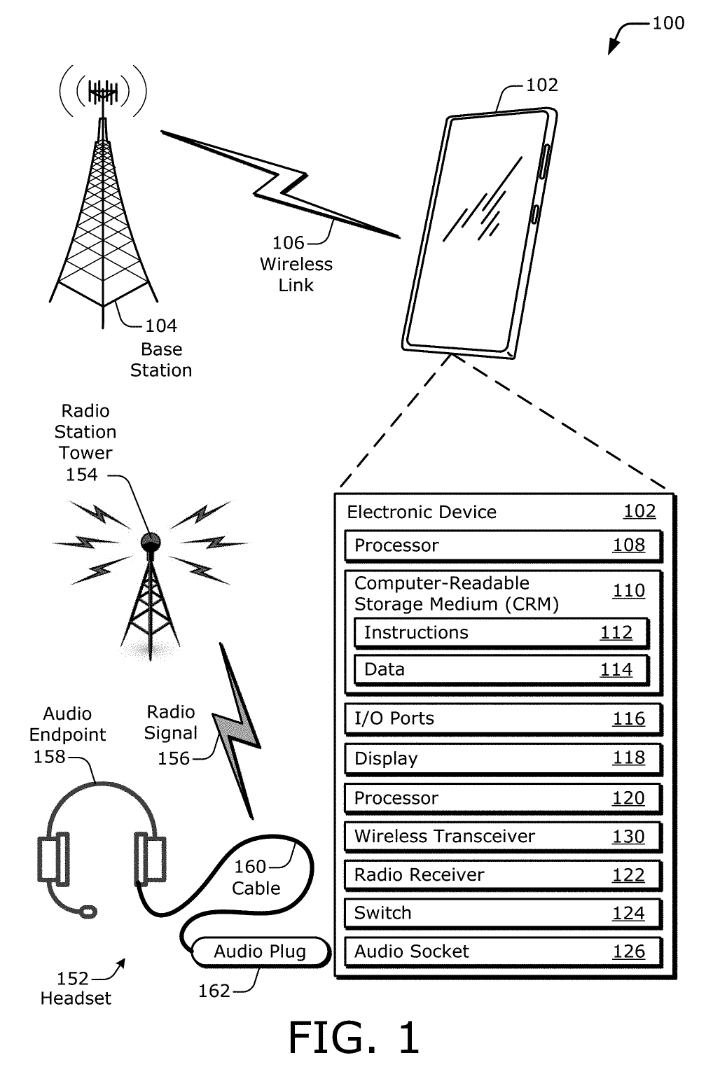

FIG. 1 illustrates an example environment 100 that includes an electronic device 102 in which headset wire selection for an antenna of the device can be implemented. In the environment 100, the electronic device 102 communicates with a base station 104 through a wireless communication link 106 (wireless link 106). In this example, the electronic device 102 is illustrated as a smart phone. However, the electronic device 102 may be implemented as any suitable computing or other electronic device, such as a cellular base station, broadband router, access point, cellular or mobile phone, gaming device, navigation device, media device, laptop computer, desktop computer, tablet computer, server, network-attached storage (NAS) device, smart appliance, vehicle-based communication system, Internet-of-Things (IoT) device, wearable device (e.g., smart watch, intelligent glasses, or smart clothing), remote control device, fitness device, medical device, and so forth.

The base station 104 communicates with the electronic device 102 via the wireless link 106, which may be implemented as any suitable type of wireless link. Although depicted as a base station tower of a cellular radio network, the base station 104 may represent or be implemented as another device, such as a satellite, cable television head-end, terrestrial television broadcast tower, access point, peer-to-peer device, mesh network node, fiber optic line, another electronic device generally, and so forth. Hence, the electronic device 102 may communicate with the base station 104 or another device via a wired connection, a wireless connection, or a combination thereof.

The wireless link 106 can include a downlink of data or control information communicated from the base station 104 to the electronic device 102 and an uplink of other data or control information communicated from the electronic device 102 to the base station 104. The wireless link 106 may be implemented using any suitable communication protocol or standard, such as 3rd Generation Partnership Project Long-Term Evolution (3GPP LTE), IEEE 802.11, IEEE 802.16, Bluetooth™, and so forth.

The electronic device 102 includes at least one processor 108 and at least one computer-readable storage medium 110 (CRM 110). The processor 108 (e.g., an application processor) may include any type of processor, such as an application processor or a multi-core processor, that is configured to execute processor-executable instructions (e.g., code) stored by the CRM 110. The CRM 110 may include any suitable type of data storage media, such as volatile memory (e.g., random access memory (RAM)), non-volatile memory (e.g., Flash memory), optical media, magnetic media (e.g., disk or tape), memory with hard-coded instructions, and so forth. In the context of this disclosure, the CRM 110 is implemented to store instructions 112, data 114, and other information of the electronic device 102, and thus does not include transitory propagating signals or carrier waves.

The electronic device 102 may also include one or more input/output ports 116 (I/O ports 116) or at least one display 118. The I/O ports 116 enable data exchanges or interaction with other devices, networks, or users. The I/O ports 116 may include serial ports (e.g., universal serial bus (USB) ports), parallel ports, audio ports, infrared (IR) ports, and so forth. The display 118 can be realized as a screen or projection that presents graphics of the electronic device 102, such as a user interface associated with an operating system, program, or application. Alternatively or additionally, the display 118 may be implemented as a display port or virtual interface through which graphical content of the electronic device 102 is communicated or presented.

For two-way or bi-directional communication purposes, the electronic device 102 also includes a modem 120, a wireless transceiver 130, and an internal antenna (not shown). The wireless transceiver 130 provides connectivity to respective networks and other electronic devices connected therewith using radio-frequency (RF) wireless signals. Additionally or alternatively, the electronic device 102 may include a wired transceiver, such as an Ethernet or fiber optic interface for communicating over a personal or local network, an intranet, or the Internet. The wireless transceiver 130 may facilitate bi-directional communication over any suitable type of wireless network, such as a wireless local area network (LAN) (WLAN), a peer-to-peer (P2P) network, a mesh network, a cellular network, a wireless wide-area-network (WWAN), or a wireless personal-area-network (WPAN). In the context of the example environment 100, the wireless transceiver 130 enables the electronic device 102 to communicate with the base station 104 and networks connected therewith. Although not explicitly shown in FIG. 1, the electronic device 102 may also include a wireless receiver to access a navigational network (e.g., the Global Positioning System (GPS) of North America or another Global Navigation Satellite System (GNSS)).

The processor 120 (e.g., a communications processor) may be realized as a communication-oriented processor, such as a baseband modem. The processor 120 may be implemented as a system on-chip (SoC) that provides a digital communication interface for data, voice, messaging, and other applications of the electronic device 102. The processor 120 may also include baseband circuitry to perform high-rate sampling processes that can include analog-to-digital conversion (ADC), digital-to-analog conversion (DAC), gain correction, skew correction, frequency translation, and so forth. The processor 120 may also include logic to perform in-phase/quadrature (I/Q) operations, such as synthesis, encoding, modulation, demodulation, and decoding. More generally, the processor 120 may be realized as a digital signal processor (DSP) or a processor that is configured to perform signal processing to support communications via one or more networks. Alternatively, ADC or DAC operations may be performed by a separate component or another illustrated component, such as the wireless transceiver 130.

The wireless transceiver 130 can include circuitry, logic, and other hardware for transmitting and receiving a wireless signal for at least one communication frequency band. In operation, the wireless transceiver 130 can implement at least one, e.g., radio-frequency transceiver unit to process data and/or signals associated with communicating data of the electronic device 102, such as via the wireless link 106. Generally, the wireless transceiver 130 can include filters, switches, amplifiers, mixers, and so forth for routing and conditioning signals that are transmitted to and received at the electronic device 102. In some cases, components of the wireless transceiver 130 are implemented as separate receiver and transmitter entities. Additionally or alternatively, the wireless transceiver 130 can be realized using multiple or different sections to implement respective receiving and transmitting operations (e.g., using separate receive and transmit chains).

As shown, the environment 100 also includes a radio station tower 154. The radio station tower 154 transmits (e.g., broadcasts) at least one radio signal 156. In some implementations, the radio signal 156 is transmitted in the 50 MHz to 150 MHz range, such as the 76 to 108 MHz range for commercial FM radio broadcasts. Accordingly, some effective lengths for monopole antennas are 2-3 feet, which is too long to efficiently incorporate directly into the electronic device 102. In such situations, a wire that is part of a headset can be used as an antenna for the electronic device 102.

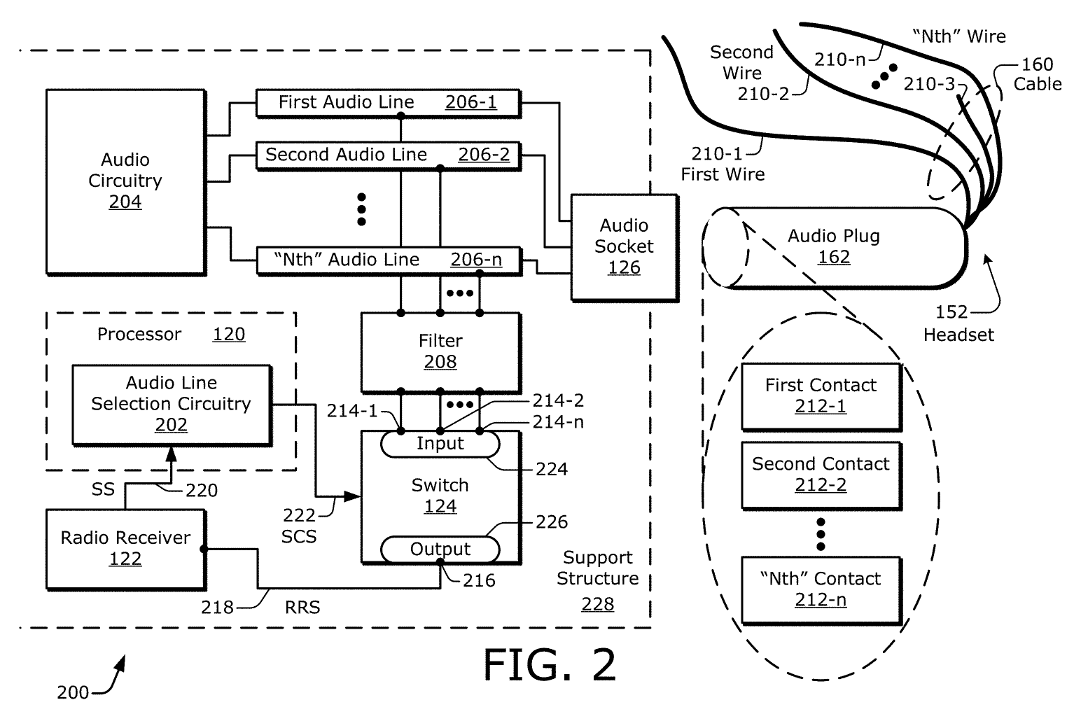

FIG. 1 further depicts a headset 152. The headset 152 includes an audio endpoint 158, a cable 160, and an audio plug 162. The audio endpoint 158 can include one or more speakers, at least one microphone, and so forth. The audio endpoint 158 can be realized as headphones, earphones, earbuds, and the like. The microphone, if present, can alternatively be disposed somewhere along the cable 160. The cable 160 extends from the audio endpoint 158 to the audio plug 162 and is coupled to both. The audio plug 162 comprises a male audio interface or audio connector that is configured to be inserted into an audio socket of an electronic device. The radio signal 156 can excite one or more wires of the cable 160, which wires are shown in FIG. 2.

As illustrated, the electronic device 102 also includes components to receive or facilitate reception of wireless signals, such as the radio signal 156. These components include, in addition to the processor 120, a radio receiver 122, a switch 124, and an audio socket 126. The radio receiver 122 and/or the switch 124 can be implemented separately from or on a same integrated circuit chip as that of the processor 120. The radio receiver 122 is configured to receive and demodulate the radio signal 156 to recover audio or other information carried by the radio signal 156, which is received via the audio socket 126. The audio socket 126 comprises a female audio interface or audio jack that is configured to accept the audio plug 162 to establish an electrical connection therebetween across one or more contacts (not shown in FIG. 1). The switch 124 is coupled between the audio socket 126 and the radio receiver 122 as described with reference to FIG. 2.

FIG. 2 is a schematic diagram 200 illustrating an example implementation of a portion of the electronic device 102 and the headset 152 of FIG. 1. The illustrated portion of the electronic device 102 includes at least one support structure 228. Examples of a support structure 228 include a printed circuit board (PCB) that can be rigid or fixed, a frame, a housing, a substrate, a laminate, a carrier, some combination thereof, and so forth. Various components can be disposed on, be affixed to, or be incorporated into the support structure 228. As illustrated, the support structure 228 includes or is coupled to the audio socket 126, the switch 124, the radio receiver 122, and the processor 120. The switch 124 is coupled between the audio socket 126 and the radio receiver 122. In some implementations, the processor 120 includes audio line selection circuitry 202 that controls the switch 124.

On the right, the headset 152 includes the audio plug 162 coupled to one end of an exploded view of the cable 160. As shown in FIG. 2, the audio plug 162 includes multiple contacts 212-1 . . . 212-n, with n representing a positive integer. Specifically, N contacts are shown: a first contact 212-1, a second contact 212-2 . . . an Nth contact 212-n. The contacts may be disposed on an external portion of the audio plug 162, an internal portion of the audio plug 162, some combination thereof, and so forth. The cable 160 includes multiple wires 210-1 . . . 212-n, with “n” representing a positive integer. Specifically, N wires are shown: a first wire 210-1, a second wire 210-2 . . . an Nth wire 210-n. A quantity represented by each instance of the variable “N” or “n” can vary in different parts of this description and with respect to different components. Here for the headset 152, however, the quantity of contacts 212-1 to 212-n is sometimes equivalent to the quantity of wires 210-1 to 210-n.

On the left of the schematic diagram 200, the support structure 228 of the electronic device 102 is depicted as including or being coupled to the processor 120, the radio receiver 122, the switch 124, and the audio socket 126. The processor 120 includes audio line selection circuitry 202 to control the switch 124. The support structure 228 further includes or is coupled to the audio circuitry 204, multiple audio lines 206-1 . . . 206-n, and at least one filter 208. Specifically, N audio lines are shown: a first audio line 206-1, a second audio line 206-2 . . . an Nth audio line 206-n, with n representing a positive integer. The multiple audio lines 206-1 to 206-n are coupled to, and extend between, the audio socket 126 and the audio circuitry 204. However, during manufacturing or assembly of an electronic device 102, the support structure 228 may have different components disposed thereon at different times. For example, at one point, the support structure 228 may include, or may be coupled to, the processor 120, the radio receiver 122, and the switch 124 before the audio socket 126 or the audio circuitry 204 is added or coupled thereto.

The multiple audio lines 206-1 to 206-n of the electronic device 102 can respectively correspond to the multiple contacts 212-1 to 212-n of the audio plug 162. Alternatively, a quantity of one may differ from a quantity of the other. Responsive to the audio socket 126 accepting the audio plug 162, respective ones of the multiple audio lines 206-1 to 206-n are electrically coupled to respective ones of the multiple contacts 212-1 to 212-n. For example, the first audio line 206-1 is electrically connected to the first contact 212-1, and the second audio line 206-2 is electrically connected to the second contact 212-2. Each audio line 206, contact 212, and wire 210 respectively corresponds to an audio signaling parameter or functionality. Example audio signaling parameters include a left audio channel, a right audio channel, a microphone channel (e.g., mono or stereo), and a ground channel.

The audio circuitry 204 is configured to process audio data that is received by the audio circuitry via an audio line 206 or that is driven by the audio circuitry 204 onto an audio line 206. Generally, the audio circuitry 204 is configured to drive audio output to the audio socket 126 over at least two audio lines of the multiple audio lines 206-1 to 206-n and to receive audio input from the audio socket 126 over at least one audio line of the multiple audio lines 206-1 to 206-n. In an example implementation, the at least two audio lines include a left audio output line and a right audio output line (e.g., a line that functions as an output relative to the electronic device 102), and the at least one audio line includes a microphone audio input line (e.g., a line that functions as an input relative to the electronic device 102). The multiple audio lines further include a ground audio line that can be coupled to a ground plane of the electronic device 102 and that can therefore be relatively noisy due to other circuits of the electronic device 102.

In example implementations, the multiple audio lines 206-1 to 206-n are coupled to the switch 124 via the at least one filter 208. The switch 124 includes an input interface 224 and an output interface 226. The input interface 224 include multiple input nodes 214-1 . . . 214-n, with n representing some positive integer. Specifically, the input interface 224 of the switch 124 includes a first input node 214-1, a second input node 214-2 . . . an Nth input node 214-n. Each respective audio line 206 of at least a portion of the multiple audio lines 206-1 to 206-n is coupled to a respective input node 214 of the multiple input nodes 214-1 to 214-n using an electrical conductor via the filter 208. The filter 208 may comprise a high-pass filter. Although not shown in FIG. 2, the filter 208 may include multiple high-pass filters, such as N high pass-filters with each respective high-pass filter being disposed along a respective electrical conductor extending between the respective audio line 206 and input node 214.

The switch 124 can comprise, for example, a single pole, multiple-throw (SPMT) switch. The output interface 226 of the switch 124 therefore includes an output node 216 in this example. The switch 124 is coupled to the radio receiver 122 via the output node 216. The switch 124 provides a received radio signal 218 (RRS 218) to the radio receiver 122. The received radio signal 218 comprises a version of the radio signal 156 (of FIG. 1) that is obtained using a currently-selected audio line 206 that is coupled to a corresponding respective wire 210 that is configured as a current antenna for the radio receiver 122. The radio receiver 122 measures (e.g., determines or estimates) a signal strength 220 (SS 220) of the received radio signal 218. The signal strength 220 can comprise, for instance, a received signal strength indicator (RSSI). In some implementations, the RSSI is realized as a received mean signal strength indicator (RMSSI); however, other signal strength indications can be used for the values of the signal strength 220.

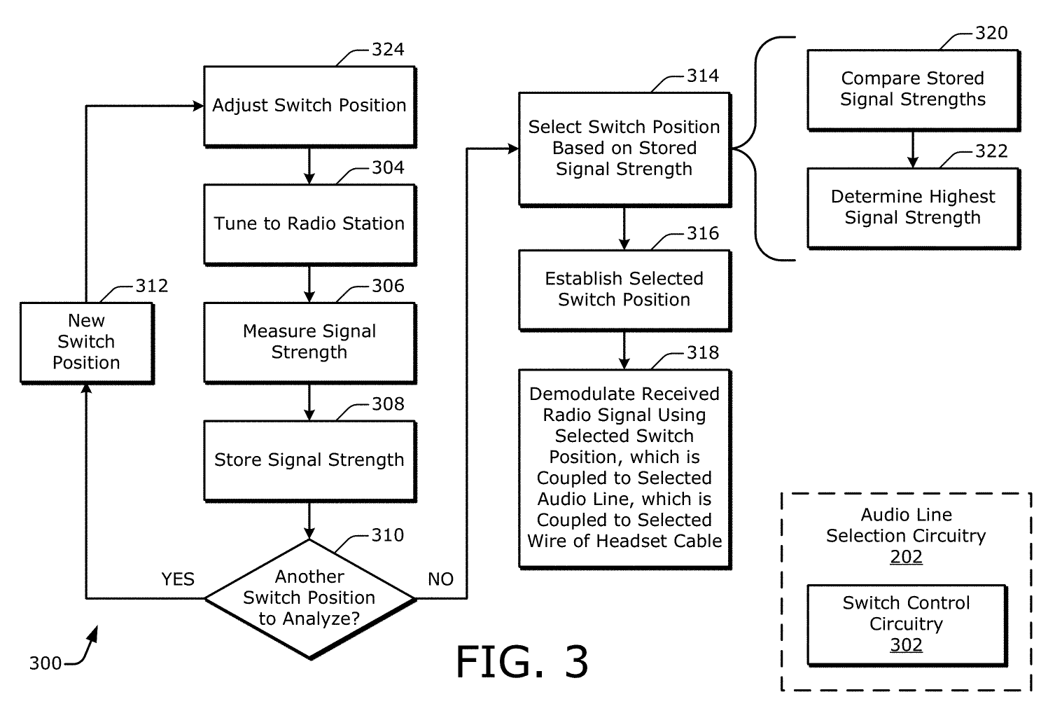

The radio receiver 122 provides the signal strength 220 to the audio line selection circuitry 202. Based on at least one signal strength 220, the audio line selection circuitry 202 formulates a switch control signal 222 (SCS 222). Algorithms, parameters, rules, and so forth for computing the switch control signal 222 are described below, such as with reference to FIG. 3. The audio line selection circuitry 202 provides the switch control signal 222 to the switch 124. The switch control signal 222 can indicate a switch position for the switch 124. Each respective switch position corresponds to a different input node 214. Responsive to the switch control signal 222, the switch 124 changes to the indicated switch position to select an input node 214 and therefore select a corresponding audio line 206 and thereby select a corresponding wire 210 for antenna usage.

Although not explicitly shown in FIG. 2, the multiple audio lines 206-1 to 206-n may include a third audio line 206-3 or a fourth audio line 206-4. Further, the multiple contacts 212-1 to 212-n may include a third contact 212-3 or a fourth contact 212-4. Similarly, the multiple input nodes 214-1 to 214-n may include a third input node 214-3 or a fourth input node, and the multiple wires 210-1 to 210-n may include a third wire 210-3 or a fourth wire.

In some implementations, the switch 124 establishes a new switch position by terminating a previous switch position. For example, the switch 124 can disconnect one input node 214 that is coupled to one audio line 206 from the output node 226 and connect another input node 214 that is coupled to another audio line 206 to the output node 226. Thus, the switch 124 provides an example switch mechanism for selectively connecting an audio line 206 of the multiple audio lines 206-1 to 206-n to the radio receiver 122 to enable different antennas to be established for the radio receiver 122 using respective ones of the multiple wires 210-1 to 210-n. An example implementation for switch 124 is depicted in FIGS. 4-1 to 4-3 and described below. An example scheme for controlling the switch 124 is described with reference to FIG. 3.

FIG. 3 is a flow chart illustrating an example scheme 300 to operate a switch 124 based on signal strength 220 (both of FIG. 2). As shown, the audio line selection circuitry 202 includes switch control circuitry 302. In example implementations, the switch control circuitry 302 establishes a switch position for the switch 124 that enables a wire 210 of the cable 160 to be used as an antenna for the radio receiver 122 in accordance with the scheme 300. At 324, a position of the switch 124 is adjusted. For example, the switch control circuitry 302 can change which input node 214 (e.g., a first input node 214-1 for a first position) of the switch 124 is connected to the output node 216 using the switch control signal 222. Alternatively, the scheme 300 can begin with a current switch position.

At 304, the radio receiver 122 tunes to a radio station having a radio signal 156 that is being broadcast from a radio station tower 154. At 306, the radio receiver 122 measures a signal strength 220 of a signal (e.g., a received radio signal 218) that is forwarded to the radio receiver 122 due to the position of the switch 124. At 308, the switch control circuitry 302 stores the signal strength 220 in association with the current switch position, which corresponds to a current audio line 206 and a current wire 210. At 310, the switch control circuitry 302 determines if there is an additional switch position to analyze.

If there is an additional switch position to analyze (as determined at block 310), then at 312 the switch control circuitry 302 determines another switch position, such as a second position for a second input node 214-2. At 324, the switch control circuitry 302 causes the switch 124 to adjust from the first switch position to the second switch position using the switch control signal 222. The switch control circuitry 302 can repeat operations 304 to 310 at the adjusted switch position. If the previous tuned radio station still has a strong signal, the tuning operation can be omitted. The loop through the operations for 304, 306, 308 310, 312, and 324 can continue until the switch control circuitry 302 cycles through each available switch position.

If, on the other hand, there is no additional switch position to analyze (as determined at block 310), then at 314 the switch control circuitry 302 selects a switch position based on a stored value for each signal strength 220 of each switch position that corresponds to each audio line 206. In some implementations, the switch control circuitry 302 compares at 320 the multiple stored signal strengths. The comparison can be performed after each available switch position has been analyzed and stored, or the comparison can alternatively be performed at each cycle and the higher of each two signal strengths stored for the next cycle. At 322, the switch control circuitry 302 determines at least a higher signal strength 220. For instance, the switch control circuitry 302 can determine a highest signal strength between or among two or more values, can determine a signal strength that is above a lowest signal strength value, and so forth.

At 316, a selected switch position is established. For example, the switch control circuitry 302 can use the switch control signal 222 to command the switch 124 to change to or remain in the selected switch position based on the signal strength measurements and the comparative analysis thereof as performed at 314. Thus, the switch control circuitry 302 provides an example control mechanism for commanding the switch 124 to establish a position based on multiple signal strengths 220-1 to 220-3 of multiple signals received via at least a portion of the multiple wires 210-1 to 210-n. At 318, the radio receiver 122 demodulates a received radio signal 218 (e.g., a commercial FM radio signal) using the selected switch position. With the selected switch position, the output node 216 is connected to a selected input node 214, which is coupled to a selected audio line 206. While the audio plug 162 is inserted in the audio socket 126, the selected audio line 206 is coupled to the selected wire 210 of the cable 160 of the headset 152.

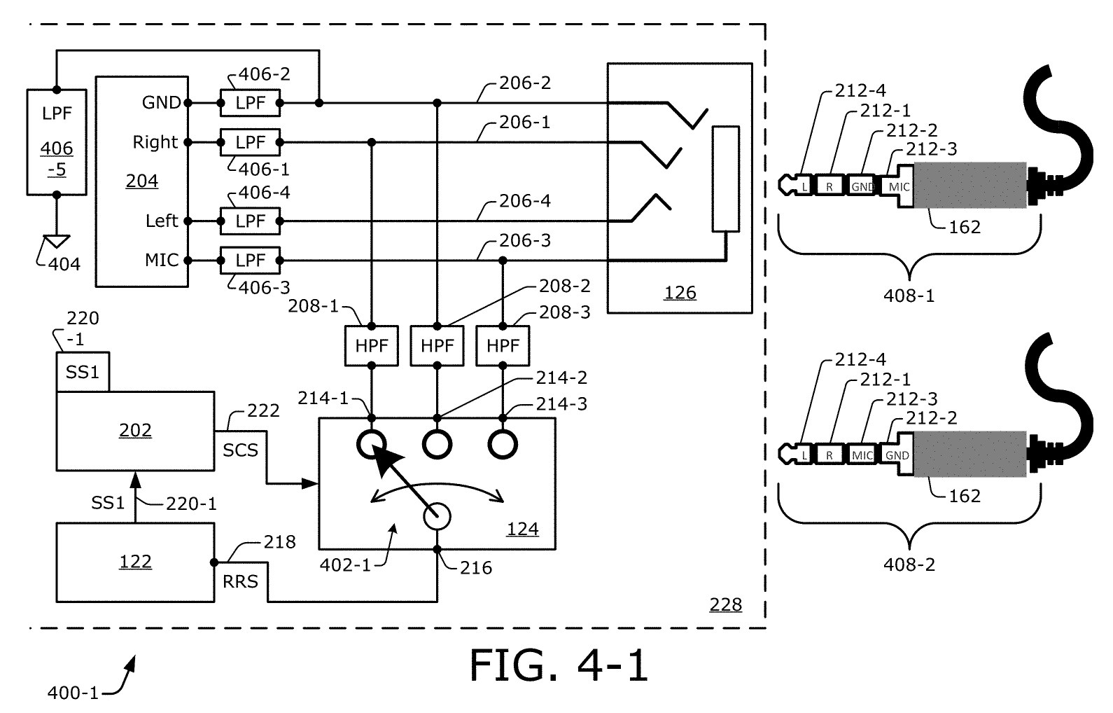

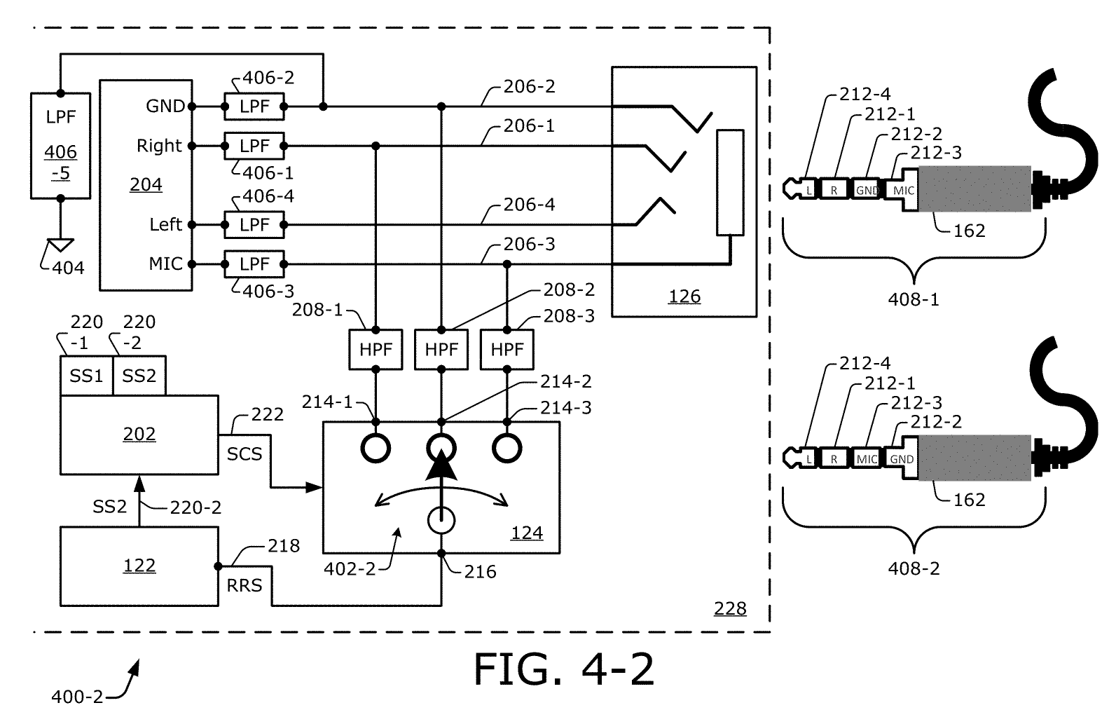

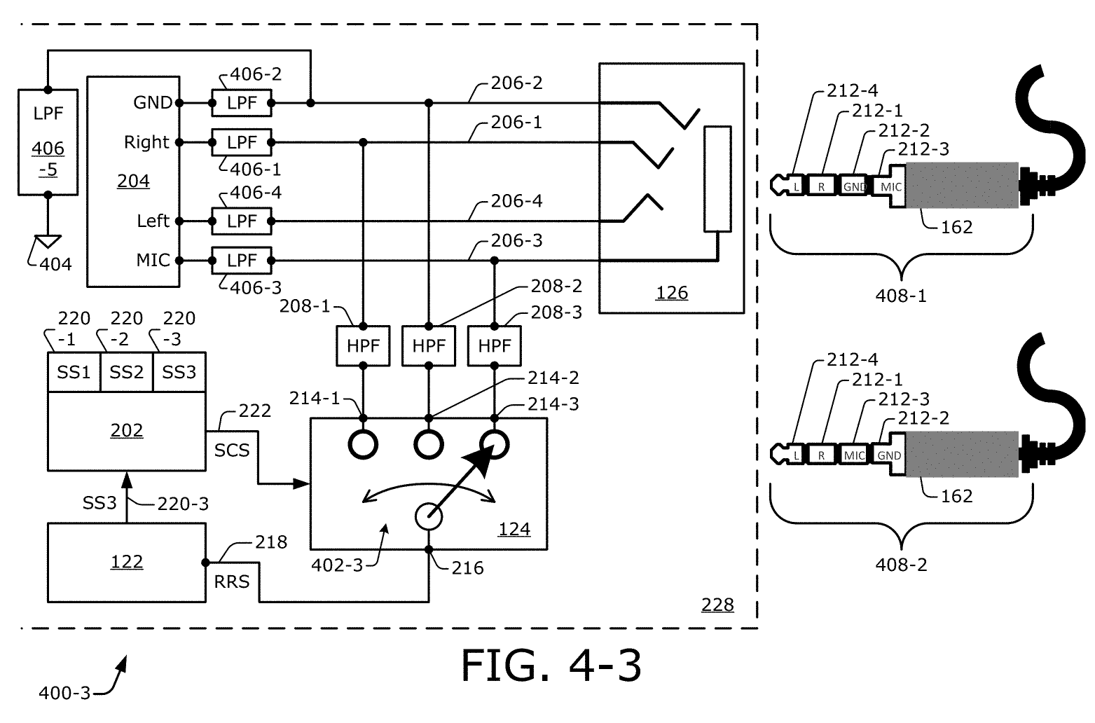

FIGS. 4-1 to 4-3 illustrate an example implementation of a support structure 228 of an electronic device 102 along with a pair of example configurations for an audio plug 162. In this example implementation, and with reference to FIG. 4-1, the audio plug 162 has one of two plug configurations, each with four contacts: a first contact 212-1, a second contact 212-2, a third contact 212-3, and a fourth contact 212-4. The electronic device 102 includes four audio lines 206 that extend between the audio circuitry 204 and the audio socket 126: a first audio line 206-1, a second audio line 206-2, a third audio line 206-3, and a fourth audio line 206-4. Thus, the variable “N” takes a value of “4” for both contacts and audio lines in this example; however, other quantities of contacts 212 or audio lines 206 may alternatively be implemented.

In this example, each audio line 206 corresponds to a respective audio parameter or functionality. As shown, the first audio line 206-1 corresponds to the right audio channel, the second audio line 206-2 corresponds to the ground audio channel, the third audio line 206-3 corresponds to the microphone audio channel, and the fourth audio line 206-4 corresponds to the left audio channel. The depicted example for the electronic device 102 corresponds to a first audio plug configuration 408-1. In the first audio plug configuration 408-1, the contacts 212 are physically ordered as follows from an external tip to an innermost portion of the plug: the fourth contact 212-4 (left audio channel), the first contact 212-1 (right audio channel), the second contact 212-2 (ground audio channel), and the third contact 212-3 (microphone audio channel). The terms “first,” “second,” “third,” and so forth are used herein to identify or distinguish similar or analogous items from one another within a given context—such as a particular implementation, a single drawing figure, or a claim. Thus, a first item in one context may differ from a first item in another context. For example, a first audio line may correspond to a right audio channel in one context and a microphone audio channel in another context.

In this example implementation, a respective lowpass filter (LPF) 406 of multiple lowpass filters 406-1 to 406-4 is coupled to the audio circuitry 204 along each respective audio line 206 of the multiple audio lines 206-1 to 206-4. Each lowpass filter 406 (LPF) may include, for instance, at least one inductive component, such as a ferrite bead or an inductor. The second audio line 206-2, which corresponds to the ground audio channel, is coupled to a ground 404 (e.g., a ground plane of the electronic device) via another lowpass filter 406-5 (LPF). As shown, the at least one high-pass filter 208 is realized as multiple high-pass filters 208-1 to 208-3 (HPF), including a first high-pass filter 208-1, a second high-pass filter 208-2, and a third high-pass filter 208-3. Each high-pass filter (HPF) may include, for instance, at least one capacitive component, such as a capacitor or a transcap variable capacitor.

The first, second, and third audio lines 206-1, 206-2, and 206-3 are coupled to a respective input node 214 of the switch 124. The fourth audio line 206-4 (the left audio channel here) is not coupled to the switch 124 and hence cannot be used to couple the left audio wire of the headset cable for use as an antenna. However, in other implementations, the left audio channel can additionally or alternatively be included in the wires that are checked for potentially providing a high signal strength as an antenna. As shown, the first audio line 206-1 (right audio channel) is coupled to the first input node 214-1 via the first high-pass filter 208-1. The second audio line 206-2 (ground audio channel) is coupled to the second input node 214-1 via the second high-pass filter 208-2. The third audio line 206-3 (microphone audio channel) is coupled to the third input node 214-3 via the third high-pass filter 208-3. Here, the switch 124 comprises a single pole, three-throw (SP3T) switch in this instance.

Continuing with FIG. 4-1, a schematic diagram 400-1 depicts the example support structure 228 with the switch 124 in a first position 402-1 to obtain a first signal strength 220-1 (SS1). With the first position 402-1, the switch 124 connects the first input node 214-1 to the output node 216. Thus, the first audio line 206-1 is coupled to the output node 216 of the switch 124. The first contact 212-1 and the first wire 210-1 (of FIG. 2) are therefore also coupled to the radio receiver 122. The radio receiver 122 can measure the first signal strength 220-1 (SS1) from the received radio signal 218 and provide the first signal strength 220-1 (SS1) to the audio line selection circuitry 202 (e.g., the switch control circuitry 302) for storage.

FIG. 4-2 is a schematic diagram 400-2 depicting the example support structure 228 of the electronic device 102 with the switch 124 in a second position 402-2 to obtain a second signal strength 220-2 (SS2). With the second position 402-2, the switch 124 connects the second input node 214-2 to the output node 216. Thus, the second audio line 206-2 is coupled to the output node 216 of the switch 124. The second contact 212-2 and the second wire 210-2 (of FIG. 2) are therefore also coupled to the radio receiver 122. The radio receiver 122 can measure the second signal strength 220-2 (SS2) and provide the second signal strength 220-2 to the audio line selection circuitry 202 for storage. The switch control circuitry 302 (of FIG. 3) of the audio line selection circuitry 202 can retain each of the signal strengths as the switch 124 is cycled through multiple switch positions in association with respective switch positions, or the switch control circuitry 302 can jettison a lower signal strength at each cycle and store a higher of two signal strengths.

FIG. 4-3 is a schematic diagram 400-3 depicting the example support structure 228 of the electronic device 102 with the switch 124 in a third position 402-3 to obtain a third signal strength 220-3 (SS3). With the third position 402-3, the switch 124 connects the third input node 214-3 to the output node 216. Thus, the third audio line 206-3 is coupled to the output node 216. The third contact 212-3 and the third wire 210-3 (of FIG. 2) are therefore also coupled to the radio receiver 122 via the output node 216 of the switch 124. The radio receiver 122 can measure the third signal strength 220-3 (SS3) and provide the third signal strength 220-3 to the switch control circuitry 302 of the audio line selection circuitry 202 for storage and analysis.

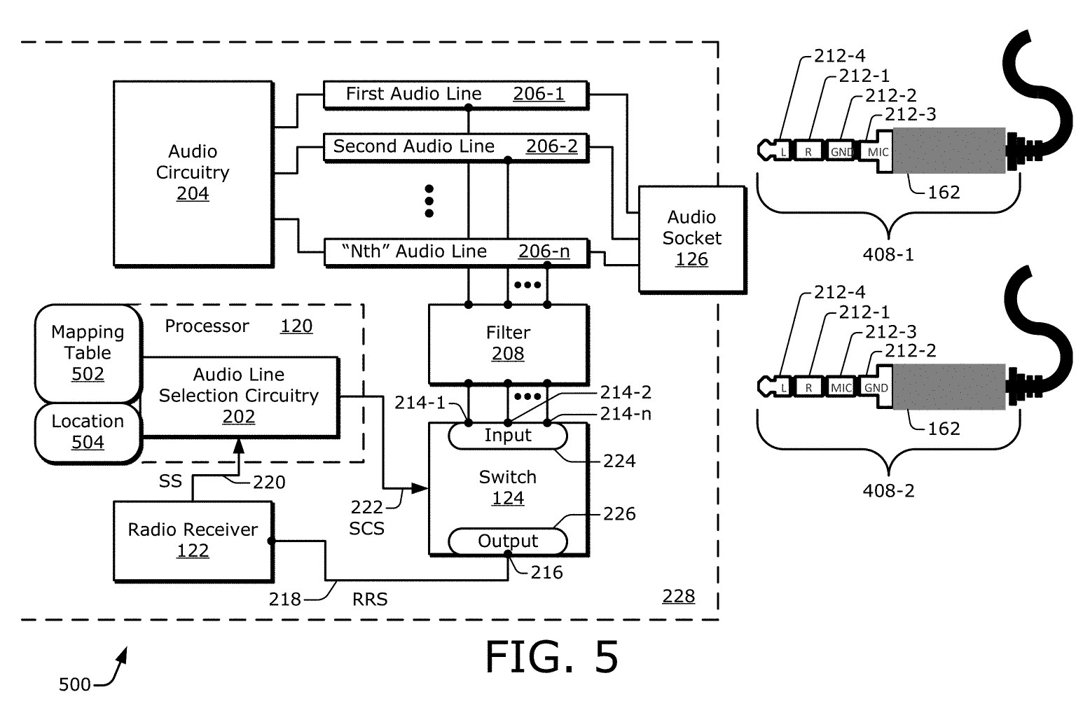

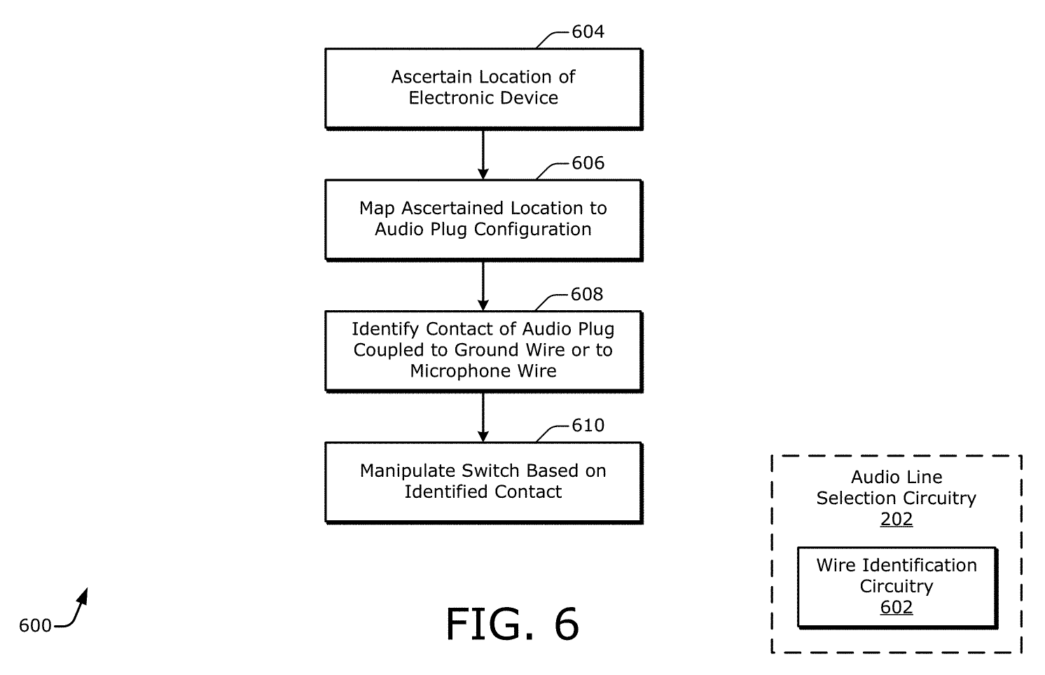

As described above, the audio plug 162 may comport with the first audio plug configuration 408-1 in which the microphone contact 212-3 is farthest from the distal tip of the audio plug. However, in some situations, the audio plug 162 may comport with the second audio plug configuration 408-2 in which the microphone contact 212-3 and the ground contact 212-2 switch positions along the audio plug relative to the first audio plug configuration 408-1. Thus, the ground contact 212-2 is farthest from the distal tip of the audio plug with the second audio plug configuration 408-2. The scheme 300 of FIG. 3 can be used to find a suitable, non-shielded wire with either configuration. However, one switch adjustment and signal strength measurement cycle can be obviated if, e.g., the position of the microphone contact 212-3 is known. FIGS. 5 and 6 are described below and are directed to an approach that can infer a likely position of the microphone or ground contact.

FIG. 5 is a schematic diagram 500 illustrating another example support structure 228 of the electronic device 102 including a switch 124 that is coupled between the multiple audio lines 206-1 to 206-n and the radio receiver 122. The audio line selection circuitry 202 identifies an audio plug configuration 408-1 or 408-2 to control the switch 124. By determining whether a connected headset likely has the first audio plug configuration 408-1 or the second audio plug configuration 408-2, the audio line selection circuitry 202 can infer relative positions of the ground contact 212-2 and the microphone contact 212-3 along the audio plug 162.

As shown, the audio line selection circuitry 202 includes or otherwise has access to a mapping table 502. In some implementations, the mapping table 502 comprises a lookup table having multiple entries. Each entry maps, or has a correspondence between, a location and a corresponding audio plug configuration. In other words, a kind of audio plug configuration that is usually sold or otherwise provided in a given location is associated with the given location in each entry of the mapping table 502. During operation, the audio line selection circuitry 202 ascertains a location 504 (e.g., a geographic region such as country) in which the electronic device 102 is currently present or situated in. The audio line selection circuitry 202 uses the mapping table 502 to infer a likely audio plug configuration based on the ascertained location 504, as is described below with reference to FIG. 6.

FIG. 6 is a flow chart illustrating an example scheme 600 to identify an audio plug configuration 408-1 or 408-2 (of FIG. 5) based on a location. As shown, the audio line selection circuitry 202 includes wire identification circuitry 602 that is configured to identify, e.g., an audio plug configuration 408-1 or 408-2 and thus a wire 210 of a corresponding headset 152. In example implementations, the electronic device 102 is communicating with one or more wireless networks. Such wireless networks can include cellular networks, Wi-Fi networks, at least one GNSS network such as GPS, and so forth. At 604, the electronic device 102 ascertains a location 504 of the device using at least one of the wireless networks. The location 504 can comprise a geographic region, such as a country or a continent. The location 504 can be specified or indicated in terms of geospatial coordinates, a country code, a defined area on the earth's surface, and so forth.

At 606, the audio line selection circuitry 202 maps the ascertained location 504 to an audio plug configuration 408-1 or 408-2. For example, the wire identification circuitry 602 can input the location 504 to the mapping table 502 to extract an indication of a corresponding audio plug configuration, such as a configuration that comports with a European standard or one that comports with a North American standard. Thus, the wire identification circuitry 602 provides a mechanism for identifying a functionality of at least one wire 210 of the multiple wires 210-1 to 210-n. At 608, the wire identification circuitry 602 identifies a contact 212 of the audio plug 162 as being coupled to a wire 210 that corresponds to a microphone functionality or a ground functionality. Thus, the wire identification circuitry 602 can determine which audio line 206 likely corresponds to a microphone audio channel or a ground audio channel.

Although the ground wire is more likely to be noisy, the ground wire is less likely to be shielded or may comprise, or function as, a shield for the other wires. Thus, a received signal strength of the ground wire can typically serve as an effective baseline for analyzing each wire for potential antenna purposes for at least some level of a radio signal is likely to be detectable via the ground wire. At 610, the switch control circuitry 302 or the wire identification circuitry 602 can manipulate the switch 124 (e.g., change a switch position 402) based on the identified contact. For example, the switch control circuitry 302 can cycle through multiple audio lines 206-1 to 206-n by starting with the one coupled to the ground wire as identified using this technique. This ensures that a radio station signal is likely to be detected and demodulated successfully to start the measuring process. Alternatively, the switch control circuitry 302 can start the signal strength measurement process with the microphone wire, can omit the microphone wire from measurement, and so forth.

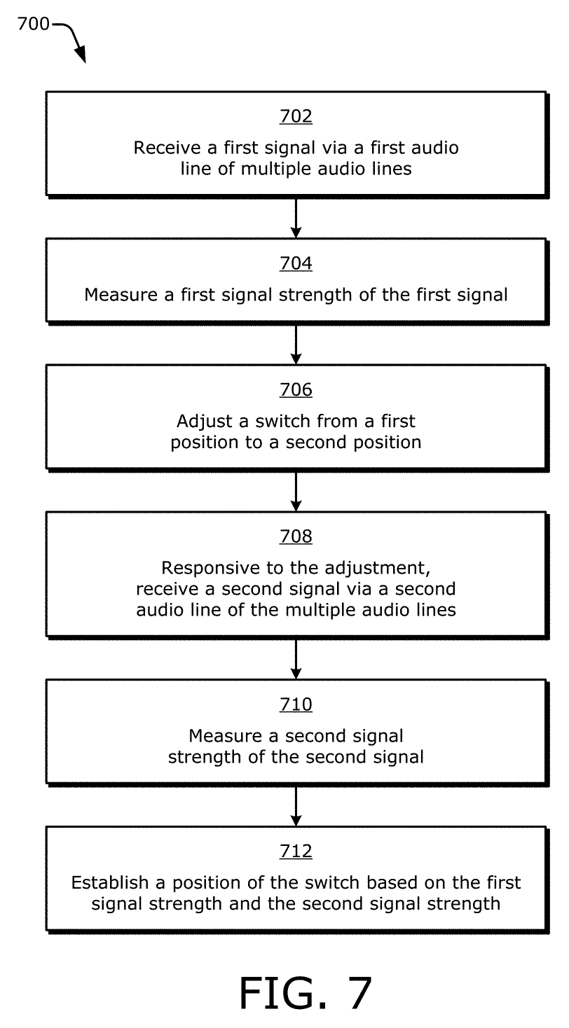

FIG. 7 is a flow diagram illustrating an example process 700 for headset wire selection for a device antenna. The process 700 is described in the form of a set of blocks 702-712 that specify operations that can be performed. However, operations are not necessarily limited to the order shown in FIG. 7 or described herein, for the operations may be implemented in alternative orders or in fully or partially overlapping manners. Also, fewer, more, and/or different operations may be implemented to perform the process 1100, or an alternative process. Operations represented by the illustrated blocks of the process 700 may be performed by an electronic device 102 having a switch 124 that couples multiple audio lines 206-1 to 206-n to a radio receiver 122. More specifically, the operations of the process 700 may be performed by audio line selection circuitry 202 that controls the switch 124 to connect different audio lines 206 to the radio receiver 122.

At block 702, a first signal is received via a first audio line of multiple audio lines. For example, the radio receiver 122 can receive a first signal (e.g., a received radio signal 218) via a first audio line 206-1 of multiple audio lines 206-1 to 206-4. The multiple audio lines 206-1 to 206-4 are coupled to an audio socket 126. To enable the signal reception, the switch 124 may connect the first audio line 206-1 to the radio receiver 122. In some implementations, the switch 124 performs the connection while an audio plug 162 is present within the audio socket 126 or responsive to detection of an audio plug 162 being inserted into the audio socket 126.

At block 704, a first signal strength of the first signal is measured. For example, the radio receiver 122 can measure a first signal strength 220-1 (SS1) of the first signal. The radio receiver 122 may perform the measurement by tuning to a radio signal 156 having a sufficiently strong signal. Switch control circuitry 302 of the audio line selection circuitry 202 may control the radio receiver 122 or store the first signal strength 220-1 (SS1) for a subsequent comparison.

At block 706, a switch is adjusted from a first position to a second position. For example, the switch 124 can change from a first position 402-1, which couples the first audio line 206-1 to the radio receiver 122, to a second position 402-2, which couples a second audio line 206-2 to the radio receiver 122. To cause this adjustment, the switch control circuitry 302 may use a switch control signal 222 to command the switch 124 to disconnect a first input node 214-1 from an output node 216 and to connect a second input node 214-2 to the output node 216.

At block 708, responsive to the adjusting, a second signal is received via a second audio line of the multiple audio lines. For example, responsive to the switch adjustment, the radio receiver 122 can receive a second signal (e.g., another received radio signal 218) via the second audio line 206-2 of the multiple audio lines 206-1 to 206-4. To enable the signal reception, the switch 124 may connect the second audio line 206-2 to the radio receiver 122. The signal reception can be performed while a wire is coupled to the second audio line 206-2 (e.g., while a wire 210 of a cable 160 is coupled to the second audio line 206-2 based on the audio plug 162 of a headset 152 being present within the audio socket 126).

At block 710, a second signal strength of the second signal is measured. For example, the radio receiver 122 can measure a second signal strength 220-2 (SS2) of the second signal. The radio receiver 122 may compute, for instance, a received mean signal strength indicator (RMSSI) as the second signal strength 220-2. The switch control circuitry 302 may compare at least the first signal strength 220-1 and the second signal strength 220-2 to determine which is highest (including higher) or lowest (including lower). In some implementations, the switch control circuitry 302 may compare more than two signal strengths, corresponding to more than two audio lines and more than two wires that are coupled thereto, to determine which signal strength is highest (including higher) or lowest (including lower).

At block 712, a position of the switch is established based on the first signal strength and the second signal strength. For example, the switch control circuitry 302 can establish a position 402-1 or 402-2 of the switch 124 based on the first signal strength 220-1 and the second signal strength 220-2. For instance, the switch control circuitry 302 may select the position 402-1 or 402-2 of the switch 124 that corresponds to a highest signal strength 220. By establishing a switch position 402 in these manners, the switch control circuitry 302 may establish which wire 210 of the cable 160 of the headset 152 is used as a device antenna for receiving the radio signal 156 to ensure that at least a suitable wire, and perhaps an optimal wire, is selected regardless of audio plug configuration 408 and/or wire shielding of the cable 160.

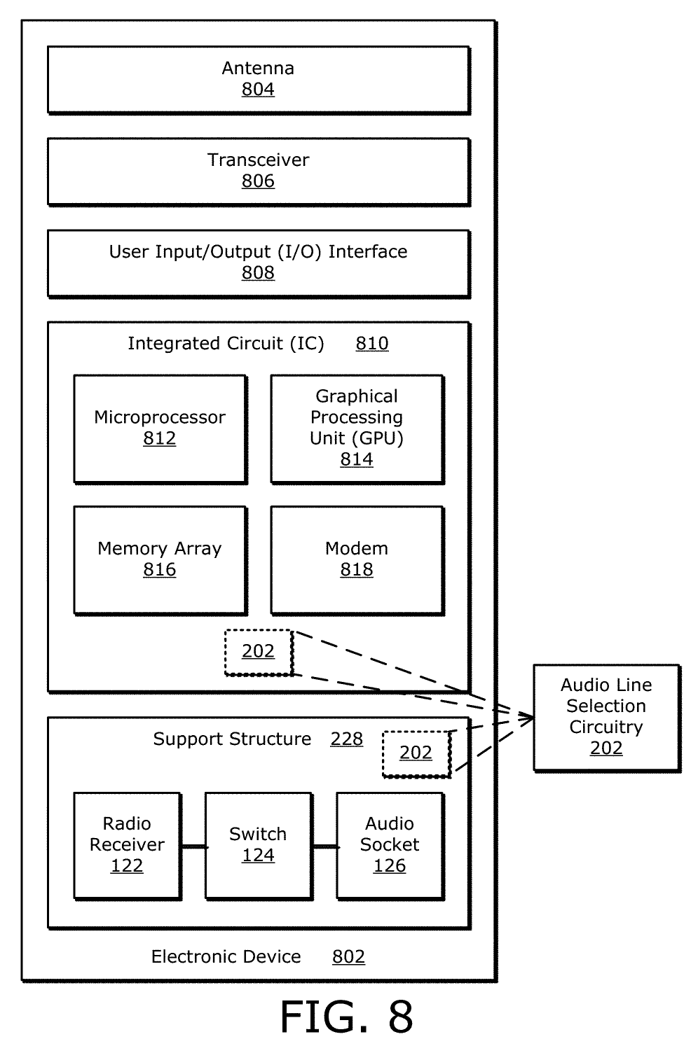

FIG. 8 illustrates an example electronic device 802, which includes at least one audio line selection switch 124, that can implement headset wire selection for a device antenna. As shown, the electronic device 802 includes at least one antenna 804, at least one transceiver 806, at least one user input/output (I/O) interface 808, and at least one integrated circuit 810. The electronic device 802 also includes at least one support structure 228, at least one radio receiver 122, the switch 124, and at least one audio socket 126. Illustrated examples of the at least one integrated circuit 810, or cores thereof, include a microprocessor 812, a graphics processing unit (GPU) 814, a memory array 816, and a modem 818. The integrated circuit 810 can also include an instance of audio line selection circuitry 202.

In one or more implementations, headset wire selection techniques for establishing a device antenna as described herein can be implemented by the electronic device 802, which is an example of the electronic device 102 of FIG. 1. The radio receiver 122, the switch 124, and the audio socket 126 can be disposed on or secured to the support structure 228. The audio socket 126 is coupled to the switch 124, which is coupled to the radio receiver 122. An instance of audio line selection circuitry 202 can alternatively or additionally be disposed on or secured to the support structure 228. In example operations, the switch 124 is configured to enable the radio receiver 122 to interface with different wires of a cable of a headset (not shown in FIG. 8) to provide at least one antenna for the radio receiver 122. In some implementations, the radio receiver 122 is configured to at least receive and process wireless signals in the FM broadcast radio band. The audio line selection circuitry 202 may be configured to perform or cause the device to implement the operations related to selecting a headset wire for use as an antenna for the radio receiver 122 as described above. Although other components of the electronic device 802 are shown as being separate from the support structure 228, one or more instances of such other components (e.g., the modem 818) may alternatively be disposed on or secured to the support structure 228.

Generally, the electronic device 802 can be a mobile or battery-powered device or a fixed device that is designed to be powered by an electrical grid. Examples of the electronic device 802 include a server computer, a network switch or router, a blade of a data center, a personal computer, a desktop computer, a notebook or laptop computer, a tablet computer, a smart phone, an entertainment appliance, or a wearable computing device such as a smartwatch, intelligent glasses, or an article of clothing. An electronic device 802 can also be a device, or a portion thereof, having embedded electronics. Examples of the electronic device 802 with embedded electronics include a passenger vehicle, industrial equipment, a refrigerator or other home appliance, a drone or other unmanned aerial vehicle (UAV), or a power tool.

For an electronic device with a wireless capability, the electronic device 802 includes an antenna 804 that is coupled to a transceiver 806 to enable bidirectional wireless communication, such as reception and transmission of one or more wireless signals, such as those in a cellular or Wi-Fi network band. The integrated circuit 810 may be coupled to the transceiver 806 to enable the integrated circuit 810 to have access to received wireless signals or to provide wireless signals for transmission via the antenna 804. The electronic device 802 as shown also includes at least one user I/O interface 808. Examples of the user I/O interface 808 include a keyboard, a mouse, a microphone, a touch-sensitive screen, a camera, an accelerometer, a haptic mechanism, a speaker, a display screen, a fingerprint or other biometric sensor, or a projector.

The integrated circuit 810 may comprise, for example, one or more instances of a microprocessor 812, a GPU 814, a memory array 816, a modem 818, and so forth. The microprocessor 812 may function as a central processing unit (CPU) or other general-purpose processor. Some microprocessors include different parts, such as multiple processing cores, that may be individually powered on or off. The GPU 814 may be especially adapted to process visual related data for display. If visual-related data is not being rendered or otherwise processed, the GPU 814 may be fully or partially powered down. The memory array 816 can store data for the microprocessor 812, the GPU 814, or the audio line selection circuitry 202. Example types of memory for the memory array 816 include random access memory (RAM), such as dynamic RAM (DRAM) or static RAM (SRAM); flash memory; and so forth. If programs are not accessing data stored in memory, the memory array 816 may be powered down overall or block-by-block. The modem 818 demodulates a signal to extract encoded information or modulates a signal to encode information into the signal. If there is no information to decode from an inbound communication or to encode for an outbound communication, the modem 818 may be idled to reduce power consumption. The integrated circuit 810 may include additional or alternative parts than those that are shown, such as an I/O interface, a sensor such as an accelerometer, a transceiver or another part of a receive or transmit chain, a customized or hard-coded processor such as an application-specific integrated circuit (ASIC), the audio line selection circuitry 202, and so forth.

The integrated circuit 810 may also comprise a system on a chip (SOC). An SOC may integrate a sufficient number of different types of components to enable the SOC to provide computational functionality as a notebook computer, a mobile phone, or another electronic apparatus using one chip, at least primarily. Components of an SOC, or an integrated circuit 810 generally, may be termed cores or circuit blocks. Examples of cores or circuit blocks include, in addition to those that are illustrated in FIG. 8, a voltage or power regulator, a main memory or cache memory block, a memory controller, a general-purpose processor, a cryptographic processor, a video or image processor, a vector processor, a radio, an interface or communications subsystem, a wireless controller, a display controller, a modem, the processor 108 or 120 (e.g., of FIG. 1), the radio receiver 122, or the audio line selection circuitry 202. Any of these cores or circuit blocks, such as a processing or GPU core, may further include multiple internal cores or circuit blocks.

In some implementations, the audio line selection circuitry 202 can be realized using a processing unit and processor-executable instructions that are stored on non-transitory processor-accessible media. Examples of a processing unit include a general-purpose processor, an application-specific integrated circuit (ASIC), a microprocessor, a digital signal processor (DSP), hard-coded discrete logic, or a combination thereof. The processor-accessible media can include memory to retain the processor-executable instructions for software, firmware, hardware modules, and so forth. Memory may comprise volatile or nonvolatile memory, such as random access memory (RAM), read only memory (ROM), flash memory, dynamic RAM (DRAM), static RAM (SRAM), or a combination thereof. Additionally or alternatively, a given controller or control circuitry can be realized at least partially using: analog circuitry; digital circuitry, such as transistors and flip-flops; combinations thereof; and so forth. The processor-executable instructions, or other forms of circuitry or controller instantiations, can be implemented in accordance with the techniques and apparatuses described herein.

Various aspects of headset wire selection for a device antenna are disclosed throughout the written description, associated figures, and/or appended claims. These aspects can be implemented independently or in combination with one another, such as is described for different aspects and implementations as set forth in the examples that follow. These aspects and implementations are presented by way of example only, and are not intended to limit the ways in which apparatuses, electronic devices or support structures thereof, printed circuit boards, circuits, components, processes, and/or techniques can be realized with headset wire selection for a device antenna.

In example aspects, an apparatus includes a radio receiver configured to demodulate a radio signal and multiple audio lines configured to be coupled to an audio socket. The apparatus also includes a switch coupled between the radio receiver and the multiple audio lines, with the switch configured to selectively connect an audio line of the multiple audio lines to the radio receiver.

In example implementations, the apparatus can further include audio circuitry coupled to the multiple audio lines. The audio circuitry can be configured to drive audio output over at least two audio lines of the multiple audio lines and receive audio input over at least one audio line of the multiple audio lines. In some cases, the at least two audio lines may include a left audio output line and a right audio output line, and the at least one audio line may include a microphone audio input line. The multiple audio lines may further include a ground audio line. In some cases, the audio circuitry may be configured to drive the audio output to the audio socket over the at least two audio lines and receive the audio input from the audio socket over the at least one audio line.

In example implementations, the audio socket can be configured to accept an audio plug of a headset. In some cases, the apparatus may further include the audio socket, and the multiple audio lines may be coupled to the audio socket. In example implementations, the apparatus can further include at least one filter coupled between the multiple audio lines and the switch. In example implementations, the switch can be realized as a single-pole, multiple-throw (SPMT) switch. In some cases, the single-pole, multiple-throw switch may be realized as a single-pole, three-throw (SP3T) switch.

In example implementations, the multiple audio lines can include a first audio line, a second audio line, a third audio line, and a fourth audio line. The switch can include a first input node, a second input node, a third input node, and an output node. The first input node can be coupled to the first audio line, the second input node can be coupled to the second audio line, and the third input node can be coupled to the third audio line. Additionally, the output node can be coupled to the radio receiver. In some cases, the switch may be configured to connect a single input node selected from the first input node, the second input node, and the third input node to the output node at any given time.

In example implementations, the switch can be configured to selectively connect the audio line of the multiple audio lines to the radio receiver based on signal strengths of signals received on respective audio lines of at least a portion of the multiple audio lines. In some cases, the radio receiver may be configured to determine the signal strengths of the signals received on the respective audio lines of the at least a portion of the multiple audio lines. Further, each of the signal strengths may comprise a received mean signal strength indicator (RMSSI). Additionally or alternatively, the apparatus may further include a processor coupled to the radio receiver and the switch, with the processor configured to generate a switch control signal based on the signal strengths of the signals received on the respective audio lines of the at least a portion of the multiple audio lines. The processor may be configured to provide the switch control signal to the switch, and the switch may be configured to selectively connect the audio line of the multiple audio lines to the radio receiver responsive to the switch control signal.

In example implementations, the apparatus can be realized as at least one of an integrated circuit chip, a chipset, or a printed circuit board (PCB). In example implementations, the apparatus can be realized as an electronic device.

In example implementations, the apparatus can further include a processor coupled to the radio receiver and the switch, with the processor configured to cycle the switch into multiple positions respectively corresponding to at least a portion of the multiple audio lines. The radio receiver can be configured to determine a respective received signal strength for each respective audio line of the at least a portion of the multiple audio lines for each respective position of the multiple positions. The processor can be configured to command the switch to establish a position of the multiple positions based on the respective received signal strength for each respective audio line of the at least a portion of the multiple audio lines. In some cases, the processor may be configured to cycle the switch into the multiple positions responsive to a detection of an insertion of an audio plug into the audio socket.

In example implementations, the apparatus can further include a processor coupled to the switch, with the processor configured to ascertain a geographic region in which the apparatus is currently located. The processor can also be configured to determine a corresponding usage for at least one audio line of the multiple audio lines based on the geographic region and to command the switch to establish a position of multiple positions based on the corresponding usage for the at least one audio line of the multiple audio lines. In some cases, the processor may be further configured to ascertain the geographic region using at least one received wireless signal and to determine the corresponding usage based on a lookup table that respectively maps geographic regions to audio plug configurations for a headset.

In example implementations, the apparatus can be realized as a printed circuit board (PCB). In example implementations, the apparatus can be realized as a support structure for an electronic device.

In example aspects, an apparatus includes a radio receiver and multiple audio lines configured to be coupled to an audio socket, with the audio socket configured to accept an audio plug of a headset having a cable that includes multiple wires. The apparatus also includes switch means for selectively connecting an audio line of the multiple audio lines to the radio receiver to enable different antennas to be established for the radio receiver using respective ones of the multiple wires.

In example implementations, the apparatus can further include control means for commanding the switch means to establish a position based on multiple signal strengths of multiple signals received via at least a portion of the multiple wires. In some cases, the radio receiver may be configured to demodulate a radio signal and to measure the multiple signal strengths of the multiple signals.

In example implementations, the apparatus can further include means for identifying a functionality of at least one wire of the multiple wires. In some cases, the means for identifying may include location means for ascertaining a geographic region of the apparatus and tabular means for mapping the geographic region to an audio plug configuration. In some cases, the switch means may operate responsive to the identified functionality of the at least one wire of the multiple wires.

In example implementations, the switch means can be configured to selectively connect to the radio receiver the audio line of the multiple audio lines that is coupled to a wire of the multiple wires that is unshielded. In example implementations, the apparatus can further include the audio socket with the multiple audio lines coupled to the audio socket. In example implementations, the apparatus can be realized as a printed circuit board (PCB). In example implementations, the apparatus can be realized as a support structure for an electronic device.

In example aspects, a method for headset wire selection for antenna usage by an electronic device includes receiving a first signal via a first audio line of multiple audio lines and measuring a first signal strength of the first signal. The method also includes adjusting a switch from a first position to a second position. Responsive to the adjusting, the method includes receiving a second signal via a second audio line of the multiple audio lines. The method additionally includes measuring a second signal strength of the second signal. The method further includes establishing a position of the switch based on the first signal strength and the second signal strength.

In example implementations, the method can further include detecting insertion of an audio plug into an audio socket coupled to the multiple audio lines and adjusting the switch to the first position responsive to the detecting. Here, the receiving of the first signal can be performed responsive to the detecting and after the adjusting of the switch to the first position.

In example implementations, the method can further include adjusting the switch from the second position to a third position and, responsive to the adjusting to the third position, receiving a third signal via a third audio line of the multiple audio lines. The method can additionally include measuring a third signal strength of the third signal. Here, the establishing can include establishing the position of the switch based on the first signal strength, the second signal strength, and the third signal strength.

In example implementations, the method can further include ascertaining a location of the electronic device and mapping the ascertained location to an audio plug configuration. The method can additionally include identifying at least one contact of an audio plug based on the audio plug configuration and manipulating the switch based on the at least one identified contact. In some cases, the receiving of the first signal via the first audio line may be performed responsive to the manipulating. In some cases, the method may further include adjusting the switch to the first position to connect an output node of the switch to the first audio line responsive to the manipulating, with the at least one identified contact comprising an identified ground contact that is coupled to the first audio line.

In example implementations, the measuring of a first signal strength can include tuning to a frequency-modulated (FM) radio station, with the first signal and the second signal comprising a received radio signal broadcast from the FM radio station at different moments. In example implementations, the establishing can include comparing the first signal strength to the second signal strength to determine a relatively lower signal strength. Here, the establishing can include establishing the position to avoid coupling an output of the switch to an audio line associated with the relatively lower signal strength.

In example implementations, the adjusting can include disconnecting a first input node of the switch from an output node of the switch and connecting a second input node of the switch to the output node of the switch. In example implementations, the method can further include processing at least one audio signal propagated over at least one of the first audio line or the second audio line.

In example aspects, an apparatus includes a printed circuit board (PCB), multiple audio lines disposed on the PCB, a radio receiver supported by the PCB, and a switch supported by the PCB. The multiple audio lines are configured to be coupled to an audio socket, which is configured to accept an audio plug of a headset. The radio receiver is configured to demodulate a radio signal. The switch is coupled between the multiple audio lines and the radio receiver and is configured to selectively connect an audio line of the multiple audio lines to the radio receiver. Any of these various aspects, implementations, and so forth can be combined, separated, rearranged, etc. to realize headset wire selection for a device antenna.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Further, items represented in the accompanying figures and terms discussed herein may be indicative of one or more items or terms, and thus reference may be made interchangeably to single or plural forms of the items and terms in this written description. Finally, although subject matter has been described in language specific to structural features or methodological operations, it is to be understood that the subject matter defined in the appended claims is not necessarily limited to the specific features or operations described above, including not necessarily being limited to the organizations in which features are arranged or the orders in which operations are performed.

What is claimed is:

1. An apparatus comprising:
multiple audio lines configured to be coupled to an audio socket;
a radio receiver configured to demodulate a radio signal; and
a switch coupled between the multiple audio lines and the radio receiver, the switch configured to selectively connect an audio line of the multiple audio lines to the radio receiver.

2. The apparatus of claim 1, further comprising:
audio circuitry coupled to the multiple audio lines, the audio circuitry configured to:
drive audio output over at least two audio lines of the multiple audio lines; and
receive audio input over at least one audio line of the multiple audio lines.

3. The apparatus of claim 2, wherein:
the at least two audio lines comprise a left audio output line and a right audio output line;
the at least one audio line comprises a microphone audio input line; and
the multiple audio lines further comprise a ground audio line.

4. The apparatus of claim 1, wherein the audio socket is configured to accept an audio plug of a headset.

5. The apparatus of claim 4, further comprising:
the audio socket,
wherein the multiple audio lines are coupled to the audio socket.

6. The apparatus of claim 1, further comprising:
at least one filter coupled between the multiple audio lines and the switch.

7. The apparatus of claim 1, wherein the switch comprises a single-pole, multiple-throw (SPMT) switch.

8. The apparatus of claim 1, wherein:
the multiple audio lines comprise a first audio line, a second audio line, a third audio line, and a fourth audio line;
the switch includes a first input node, a second input node, a third input node, and an output node;
the first input node is coupled to the first audio line, the second input node is coupled to the second audio line, and the third input node is coupled to the third audio line; and
the output node is coupled to the radio receiver.

9. The apparatus of claim 8, wherein the switch is configured to connect a single input node selected from the first input node, the second input node, and the third input node to the output node at any given time.

10. The apparatus of claim 1, wherein the switch is configured to selectively connect the audio line of the multiple audio lines to the radio receiver based on signal strengths of signals received on respective audio lines of at least a portion of the multiple audio lines.

11. The apparatus of claim 10, wherein the radio receiver is configured to determine the signal strengths of the signals received on the respective audio lines of the at least a portion of the multiple audio lines.

12. The apparatus of claim 11, further comprising:
a processor coupled to the radio receiver and the switch, the processor configured to generate a switch control signal based on the signal strengths of the signals received on the respective audio lines of the at least a portion of the multiple audio lines, the processor configured to provide the switch control signal to the switch,
wherein the switch is configured to selectively connect the audio line of the multiple audio lines to the radio receiver responsive to the switch control signal.

13. The apparatus of claim 1, wherein the apparatus comprises at least one of an integrated circuit chip, a chipset, or a support structure for an electronic device.

14. The apparatus of claim 1, wherein the apparatus comprises an electronic device.

15. The apparatus of claim 1, further comprising:
a processor coupled to the radio receiver and the switch, the processor configured to cycle the switch into multiple positions respectively corresponding to at least a portion of the multiple audio lines, wherein:
the radio receiver is configured to determine a respective received signal strength for each respective audio line of the at least a portion of the multiple audio lines for each respective position of the multiple positions; and
the processor is configured to command the switch to establish a position of the multiple positions based on the respective received signal strength for each respective audio line of the at least a portion of the multiple audio lines.

16. The apparatus of claim 1, further comprising:
a processor coupled to the switch, the processor configured to:
ascertain a geographic region in which the apparatus is currently located;
determine a corresponding usage for at least one audio line of the multiple audio lines based on the geographic region; and
command the switch to establish a position of multiple positions based on the corresponding usage for the at least one audio line of the multiple audio lines.

17. The apparatus of claim 16, wherein the processor is further configured to:
ascertain the geographic region using at least one received wireless signal; and
determine the corresponding usage based on a lookup table that respectively maps geographic regions to audio plug configurations for a headset.

18. An apparatus comprising:
multiple audio lines configured to be coupled to an audio socket, the audio socket configured to accept an audio plug of a headset having a cable that includes multiple wires;
a radio receiver; and
switch means for selectively connecting an audio line of the multiple audio lines to the radio receiver to enable different antennas to be established for the radio receiver using respective ones of the multiple wires.

19. The apparatus of claim 18, further comprising:
control means for commanding the switch means to establish a position based on multiple signal strengths of multiple signals received via at least a portion of the multiple wires.

20. The apparatus of claim 19, wherein the radio receiver is configured to:
demodulate at least one radio signal; and
measure the multiple signal strengths of the multiple signals using the at least one radio signal.

21. The apparatus of claim 18, further comprising:
means for identifying a functionality of at least one wire of the multiple wires.

22. The apparatus of claim 21, wherein:
the means for identifying comprises:
location means for ascertaining a geographic region of the apparatus; and
tabular means for mapping the geographic region to an audio plug configuration; and
the switch means operates responsive to the functionality identified for the at least one wire of the multiple wires.

23. The apparatus of claim 18, wherein the switch means is configured to selectively connect to the radio receiver the audio line of the multiple audio lines that is coupled to a wire of the multiple wires that is unshielded.

24. A method for headset wire selection for antenna usage by an electronic device, the method comprising:
receiving a first signal via a first audio line of multiple audio lines;
measuring a first signal strength of the first signal;
adjusting a switch from a first position to a second position;
responsive to the adjusting, receiving a second signal via a second audio line of the multiple audio lines;
measuring a second signal strength of the second signal;
establishing a position of the switch based on the first signal strength and the second signal strength.

25. The method of claim 24, further comprising:
adjusting the switch from the second position to a third position;
responsive to the adjusting to the third position, receiving a third signal via a third audio line of the multiple audio lines; and
measuring a third signal strength of the third signal,
wherein the establishing comprises establishing the position of the switch based on the first signal strength, the second signal strength, and the third signal strength.

26. The method of claim 24, further comprising:
ascertaining a location of the electronic device;
mapping the ascertained location to an audio plug configuration;
identifying at least one contact of an audio plug based on the audio plug configuration; and
manipulating the switch based on the at least one identified contact.

27. The method of claim 26, further comprising adjusting the switch to the first position to connect an output node of the switch to the first audio line responsive to the manipulating, the at least one identified contact comprising a ground contact that is coupled to the first audio line.

28. The method of claim 24, wherein the establishing comprises:
comparing the first signal strength to the second signal strength to determine a relatively lower signal strength,
wherein the establishing comprises establishing the position to avoid coupling an output of the switch to an audio line associated with the relatively lower signal strength.

29. The method of claim 24, wherein the adjusting comprises:
disconnecting a first input node of the switch from an output node of the switch; and
connecting a second input node of the switch to the output node of the switch.

30. An electronic device comprising:
an audio socket;
multiple audio lines coupled to the audio socket;
audio circuitry coupled to the multiple audio lines;
a radio receiver configured to demodulate a radio signal; and
a switch coupled between the multiple audio lines and the radio receiver, the switch configured to selectively connect an audio line of the multiple audio lines to the radio receiver.
